(19) United States
(12) Patent Application Publication
(10) Pub. No.: US 2026/0077647 A1
(43) Pub. Date: Mar. 19, 2026

(54) TRANSFER CASE SINGLE SPEED WITH NEUTRAL POSITION AND BEARING PLATE

(71) Applicant: Magna Powertrain of America, Inc., Troy, MI (US)

(72) Inventors: Luis Angel Gomez Torres, Saltillo (MX); Homero Jesus Gómez Flores, Saltillo (MX); Mario Alberto Martínez Cólica, Arteaga (MX)

(21) Appl. No.: 19/323,264

(22) Filed: Sep. 9, 2025

Related U.S. Application Data
(60) Provisional application No. 63/694,289, filed on Sep. 13, 2024.

(51) Int. Cl. B60K 23/08; B60K 17/344; F16H 57/02; F16H 57/021; F16H 63/04; F16H 63/32

(52) U.S. Cl. CPC B60K 23/08; B60K 17/344; F16H 57/021; F16H 63/04; F16H 63/32; F16H 2057/02052; F16H 2200/0017; F16H 2200/0034; F16H 2200/2005; F16H 2200/2094

(57) ABSTRACT

A transfer case includes an internal bore that receives a bearing plate assembly providing support for an input shaft. The bore is sized and configured such that the bearing plate assembly replaces a planetary gear assembly of a similar size. The transfer case having the bearing plate assembly is a single speed transfer case with a neutral operating mode. A shiftable collar has a first position that driving couples the input shaft to a first output shaft and a second position the interrupts the torque transfer therebetween. The collar is splined on the first output shaft and rotates with the first output shaft. A second end of the input shaft has a cylindrical outer surface and is supported by the bearing plate assembly and rotates relative to the bearing plate assembly, rather than including a sun gear that drives a planetary.

### CROSS-REFERENCE TO RELATED APPLICATIONS

This application claims the benefit of U.S. Provisional Patent Application No. 63/694,289, filed Sep. 13, 2024, the entire content of which is hereby incorporated by reference in its entirety.

### FIELD

The present disclosure relates to a single speed transfer case with a selectable neutral operating mode. The present disclosure includes the ability to adapt a two-speed transfer case to a single speed transfer case providing a neutral operating mode while sharing components to provide a platform approach to the concept. By removing the low range planetary geartrain, eliminating the sun gear form on the input shaft, adding a bearing plate to support the input shaft, and re-utilizing other surrounding components, a single speed transfer case with a neutral operating mode is provided cost effectively and with improved efficiency.

### BACKGROUND

This section provides background information related to the present disclosure which is not necessarily prior art.

Traditionally, transfer cases have been offered either in a single speed version or a two-speed version. Two-speed transfer cases include a two-speed planetary and a range shifting mechanism with a dog-type range clutch which can be selectively actuated by the vehicle operator for shifting between four-wheel high-range and low-range drive modes. When in low-range, the planetary is engaged and multiples the torque provided to the front and rear drivelines of the vehicle. The range shift mechanism and the dog-type range clutch also includes a distinct neutral position where power is interrupted between the transmission and the front and rear outputs of the transfer case. Most consumers purchase a two-speed transfer case for the improved off-roading capability or tractive effort when operating in low-range, but a smaller portion of the end users purchase a two-speed transfer case only for the capability of a neutral mode. The neutral mode is specifically useful when the vehicle is flat towed, meaning all four wheels remain engaged with the road surface. This is often used for towing such vehicles behind recreational vehicles. Many of these end users are not requiring the off-road capability a two-speed transfer case provides. In all operating modes the additional planetary rotates resulting in reduced operating efficiency. A neutral mode must be provided somewhere in the driveline between the ground engaging wheels and the transmission output to prevent rotation of the transmission as damage will occur. If the transmission is rotated when not normally operated, the absence of the engine running driving the transmission input means the transmission pump, which provides the necessary lubrication, is not functioning.

### SUMMARY

This section provides a general summary of the many aspects associated with the inventive concepts embodied in the teachings of the present disclosure and is not intended to be considered a complete listing of its full scope of protection nor all of its features and advantages.

It is an object of the present disclosure to provide an alternative transfer case design offering a single speed solution with a selectable neutral by removing the planetary and reutilizing most of the remaining transfer case components. This will provide a cost-effective solution, particularly as numerous components are reused between either version of the transfer case and as both transfer cases are very similar in design allowing assembly to be performed without significant changes to the manufacturing process. As an added benefit the end user will be provided an efficiency improvement with the reduction in losses associated with the planetary.

Accordingly, it is an aspect of the present disclosure to adapt a high volume produced two-speed transfer case into a single speed transfer case with a selectable neutral operating mode with minimal overall changes. The present disclosure removes the low range planetary geartrain of the two-speed range unit and modifies the input shaft of a two-speed transfer case while adding a bearing plate and bearing to support the input shaft. A majority of other surrounding components are re-utilized to create a single speed transfer with neutral in a cost effective manner with higher efficiency due to losses of the planetary gearset are eliminated. To describe the present disclosure's benefit, features of the present disclosure will be compared to portions of a standard two-speed transfer case. The standard two-speed transfer case may be the one as described in the applicant's US Patent U.S. Pat. No. 7,694,598B2.

In a related aspect of the present disclosure, a donut shaped bearing plate with similar outer dimension of the planetary ring gear is provided. This circular bearing plate outer diameter is pressed into the existing bore which normally receives the planetary ring gear in the standard two-speed transfer case. The bearing plate will include a ball bearing at an inward diameter position which mates and supports a second end of the input shaft. The input shaft is modified to eliminate the clutch teeth found in the two-speed transfer case version which normally mates to the sun gear of the planetary and instead be provided with a smoother outer diameter to mate to the inner race of the ball bearing. The range actuation system including actuator and fork are reutilized from the two-speed transfer case and are used to move a similar shift collar axially between a connected mode engaging the input shaft to rear output shaft, and a disconnected or neutral mode where the input shaft and rear output shaft are not rotationally fixed via the shift collar, interrupting power flow from the transmission and the remaining driveline. The shifting mechanism of the range actuation system may be modified to provide only two selectable positions of the shift collar or the electronic control unit may be reprogrammed to control the range actuation system of the standard two-speed transfer case to move the shift collar to only two positions. The latter would result in further reutilized components and reduced costs.

Further details comparing the present disclosure to a standard two-speed transfer case will be provided to better understand the benefits of utilizing such an arrangement versus providing a solution without reuse of components.

### BRIEF DESCRIPTION OF THE DRAWINGS

The drawings described herein are for illustrative purposes only of selected embodiments and are not intended to limit the scope of the present disclosure. The inventive concepts associated with the present disclosure will be more readily understood by reference to the following description in combination with the accompanying drawings wherein:

FIG. 1 illustrates a four-wheel drive vehicle equipped with a transfer case.

FIG. 2 is a sectional view of a standard two-speed transfer case.

FIG. 3 is an enlarged partial view of the range unit of a standard two-speed transfer case.

FIG. 4 is an enlarged partial view of the disconnect unit of the present disclosure in the revised transfer case providing a neutral mode, shown positioned in a connected non-neutral state.

### DETAILED DESCRIPTION

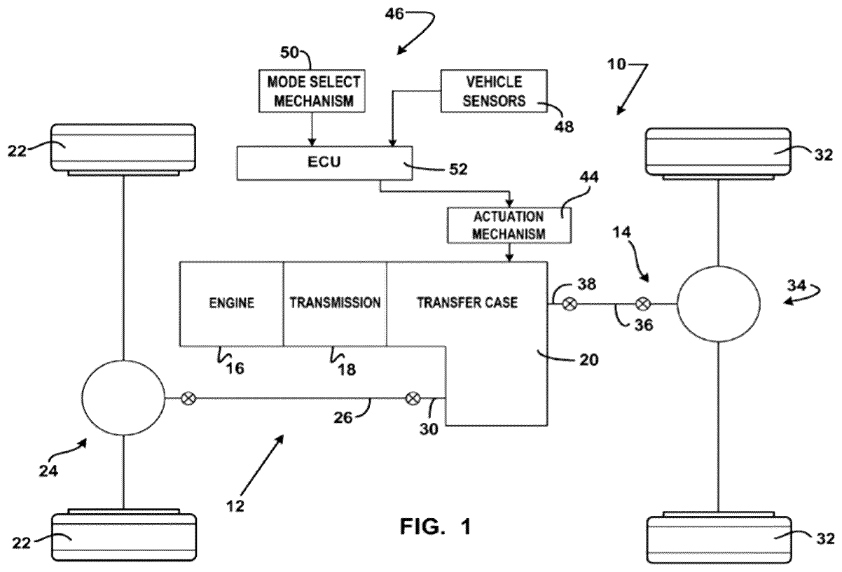

Referring now to FIG. 1 of the drawings which is applicable to the prior art and the present disclosure, a four-wheel drive vehicle 10 is schematically shown to include a front driveline 12, a rear driveline 14, and a powertrain for generating and selectively delivering rotary tractive power (i.e., drive torque) to the drivelines. The powertrain is shown to include an engine 16 and a transmission 18 which may be of either the manual or automatic type. In the particular embodiment shown, vehicle 10 further includes a transfer case 20 (which can be replaced with transfer case 20′ of the present disclosure) for transmitting drive torque from the powertrain to front driveline 12 and rear driveline 14. Front driveline 12 includes a pair of front wheels 22 connected via a front axle assembly 24 and a front propshaft 26 to a front output shaft 30 of transfer case 20. Similarly, rear driveline 14 includes a pair of rear wheels 32 connected via a rear axle assembly 34 and a rear propshaft 36 to a rear output shaft 38 of transfer case 20.

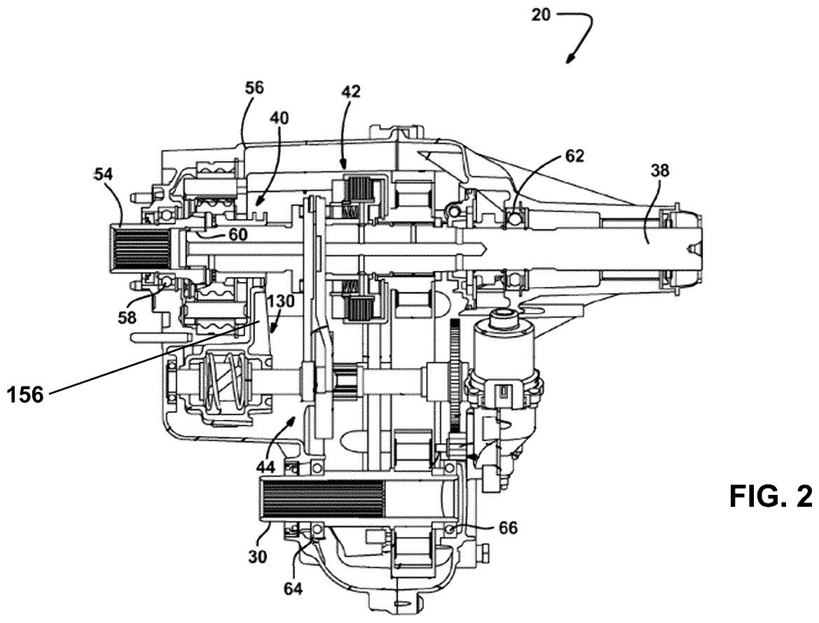

FIG. 2. Provides a cross-sectional view of a standard two speed transfer case 20 of the prior art equipped with a two-speed range unit 40, a mode clutch assembly 42, and a power-operated actuation mechanism 44 that is operable to control coordinated shifting of range unit 40 and adaptive engagement of mode clutch assembly 42. In addition, a control system 46 is provided for controlling actuation of actuation mechanism 44. Control system 46 includes vehicle sensors 48 for detecting real time operational characteristics of motor vehicle 10, a mode select mechanism 50 for permitting the vehicle operator to select one of the available drive modes and an electronic control unit (ECU) 52 that is operable to generate electric control signals in response to input signals from sensors 48 and mode signals from mode select mechanism 50. This provides the standard two speed transfer case 20 with the functionality of a 2WD mode, a neutral mode, a 4WD mode, and a 4WD low mode.

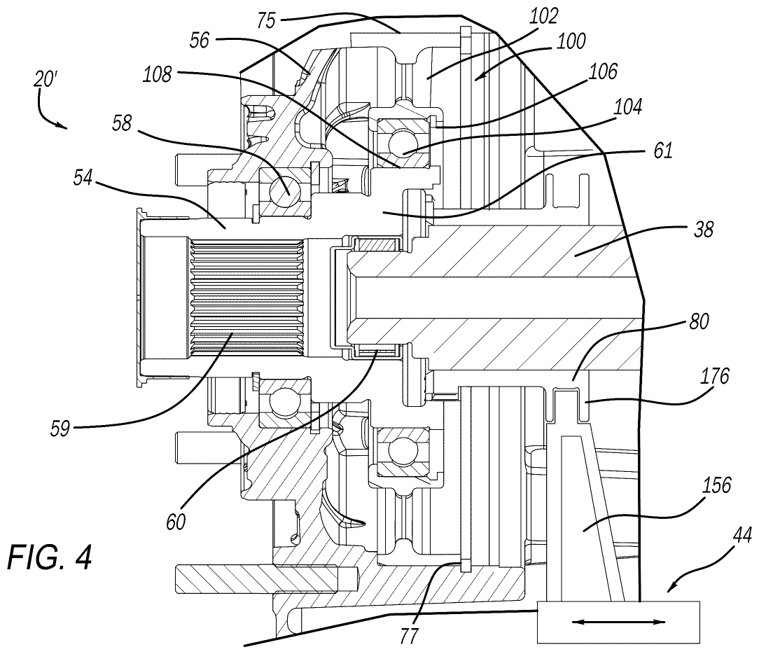

The single speed transfer case 20′ of the present disclosure is equipped with a generally similar disconnect unit 40′ with differences indicated when describing FIG. 4. The mode clutch assembly 42 and a power-operated actuation mechanism 44 that is operable to control coordinated shifting of disconnect unit 40′ and adaptive engagement of mode clutch assembly 42 may be carried over from two-speed transfer case 20. Control system 46 is provided for controlling actuation of actuation mechanism 44 including vehicle sensors 48 for detecting real time operational characteristics of motor vehicle 10, a mode select mechanism 50 for permitting the vehicle operator to select one of the available drive modes and an electronic control unit (ECU) 52 that is operable to generate electric control signals in response to input signals from sensors 48 and mode signals from mode select mechanism 50 as in two-speed transfer case 20. This provides the single speed transfer case 20′ with the functionality of a 2WD mode, a neutral mode, and a 4WD mode. As the two-speed range unit 40 is replaced with the disconnect unit 40′ without a planetary, a 4WD low operating mode is not provided in the transfer case 20′.

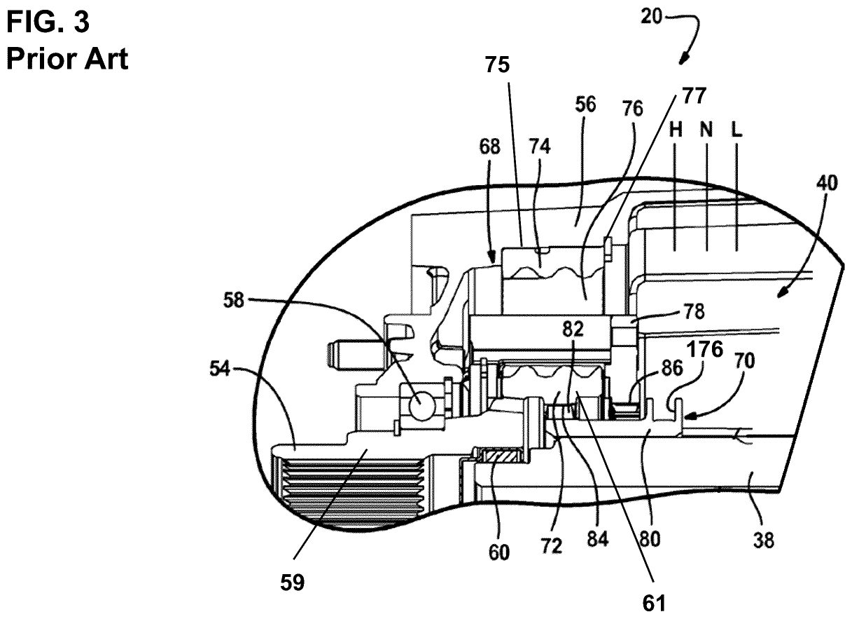

Transfer case 20 is shown in FIG. 3 to include an input shaft 54 that is adapted to be coupled for driven connection with an output shaft of transmission 18. Input shaft 54 is supported in a housing 56 by a bearing assembly 58 for rotation about a first rotary axis on a first end 59. Rear output shaft 38 is supported between input shaft 54 and housing 56 for rotation about the first rotary axis via a pair of laterally-spaced bearing assemblies 60 and 62. In addition, front output shaft 30 is supported in housing 56 for rotation about a second rotary axis by a pair of bearing assemblies 64 and 66. This general arrangement also applies to transfer case 20′ of the present disclosure.

As best seen from FIGS. 2 and 3, range unit 40 of a standard two-speed transfer case 20 is shown to generally include a planetary gearset 68 and a dog clutch 70. Planetary gearset 68 has a sun gear 72 driven by input shaft 54, a ring gear 74 non-rotatably fixed to housing 56 and a plurality of planet gears 76 rotatably supported from a planet carrier 78. A sun gear 72 is integrated into the second end 61 of input shaft 54. Ring gear 74 is pressed into a circular bore 75 machined into housing 56. A snap ring 77 is inserted into a groove of housing 56 to further ensure the axial location of ring gear 74 into bore 75 is fixed. As seen, planet gears 76 are meshed with both sun gear 72 and ring gear 74. Planetary gearset 68 functions to drive planet carrier 78 at a reduced speed relative to input shaft 54. Dog clutch 70 includes a shift collar 80 coupled via a spline connection for rotation with and axial sliding movement on rear output shaft 38. Shift collar 80 has external clutch teeth 82 adapted to selectively engage either internal clutch teeth 84 formed on input shaft 54 or internal clutch teeth 86 formed on a carrier ring associated with planet carrier 78. Shift collar 80 includes a slot 176 which receives a fork 156. Fork 156 is part of range actuation assembly 130 moving shift collar 80 axially in between positions. Shift collar 80 is shown located in a high (H) range position such that its clutch teeth 82 are engaged with clutch teeth 84 on input shaft 54. As such, a direct speed ratio or “high-range” drive connection is established between input shaft 54 and rear output shaft 38. Shift collar 80 is axially moveable on rear output shaft 38 from its H range position through a central neutral (N) position into a low (L) range position. Location of shift collar 80 in its N position functions to disengage its clutch teeth 82 from both input shaft clutch teeth 84 and carrier clutch teeth 86, thereby uncoupling rear output shaft 38 from driven connection with input shaft 54. In contrast, movement of shift collar 80 into its L range position causes its clutch teeth 82 to engage clutch teeth 86 on planet carrier 78, thereby establishing a reduced speed ratio or “low-range” drive connection between input shaft 54 and rear output shaft 38. It will be appreciated that planetary gearset 68 and non-synchronized dog clutch 70 function to provide transfer case 20 with a two-speed (i.e., high-range and low-range) feature.

FIG. 4. provides a view similar to FIG. 3 but now with disconnect unit 40′ within transfer case 20′ of the present disclosure. Components with similar design and functionality will be carried over with the same identifiers. New components or components significantly modified are provided with different identifiers. Housing 56 remains unchanged in the present disclosure particularly still including bore 75 previously receiving ring gear 74 and bearing 58 supporting input shaft 54. Bore 75 is now utilized to receive bearing plate assembly 100 which includes a bearing plate 102, bearing 104, and bearing plate snap ring 106 axially securing bearing 104 to bearing plate 102.

Bearing plate assembly 100 is retained to housing 56 via a press fit and snap ring 77. Input shaft 54′ is modified from the two-speed transfer with changes made on only the second end 61. The previous sun gear 72 feature is eliminated and is replaced with a machined outer diameter 108 which connects with inner race of bearing 104. As only the sun gear feature 72 is eliminated to create input shaft 54′, input shaft 54′ may be made from the same forging or blank as used for input shaft 54, providing further cost savings. Input shaft 54′ is supported via bearing assembly 58 on a first end 59 and bearing 104 on the second end 61 for rotation about a first rotary axis. Providing support on each ends ensures alignment between input shaft 54′, collar 80, and rear output shaft 38. Dog clutch 70 is reutilized in general from the two-speed transfer case version, including an unchanged shift collar 80 coupled via a spline connection for rotation with and axial sliding movement on rear output shaft 38. Shift collar 80 has external clutch teeth 82 adapted to selectively engage only internal clutch teeth 84 formed on input shaft 54′. Shift collar 80 includes the same slot 176 that receives fork 156. Fork 156 is part of range actuation assembly 130 that moves shift collar 80 axially in between positions. In the first position as shown in FIG. 4 external teeth 82 of collar 80 are engaged to internal clutch teeth 84 of shaft 54′, resulting in power to be transferred from input 54′ to rear output shaft 38 and further into rear axle assembly 34 and front axle assembly 24 dependent on the state of mode clutch assembly 42. When shift collar 80 is moved forward to a second operating position, no engagement occurs between input shaft 54′ internal teeth 84 and external teeth 82 of collar 80, resulting in no torque transfer and providing a neutral operating mode. There is no third position required. When a drive mode is required, shift collar 80 will be moved back to the first position by range actuation assembly 130.

As can now be understood, two-speed transfer case 20 can be converted to a single speed transfer case 20′ with changes as described. In summary, planetary 68 is eliminated and replaced by bearing plate assembly 100, while input shaft 54′ is modified relative to shaft 54 to remove the sun gear 72 feature while still including teeth 84. As these changes are minimal, a unique product can be offered to the end users seeking a neutral operating mode without the need of purchasing a two-speed transfer case and the resultant negatives including additional weight and efficiency losses for a feature that is not required.

What is claimed:

1. A transfer case comprising
an input shaft;
a first output shaft;
bearings mounted within said housing respectively supporting the input shaft and first output shaft
a housing with a bore;
a bearing plate assembly disposed in the bore that provides support to the input shaft;
a dog clutch positioned around the first output shaft and having including a shiftable collar that is axially moveable along the first output shaft;
a power-operated actuation mechanism that axially moves a shiftable collar;
wherein in a first position of the shiftable collar, the shiftable collar provides torque transfer between the input shaft and the first output shaft, and in a second position toque transfer is interrupted between the input shaft and the first output shaft.

2. The transfer case of claim 1, further comprising a second output shaft that is radially offset from the first input shaft.

3. The transfer case of claim 2, wherein the first and second output shafts drive separate axles and transfer torque therebetween to define a four wheel drive mode.

4. The transfer case of claim 1, wherein the shiftable collar is coaxial with the first output shaft in a splined connection, wherein the shiftable collar is coupled for co-rotation with the first output shaft.

5. The transfer case of claim 4, wherein the shiftable collar is coaxial with the input shaft and rotates with the input shaft in the first position.

6. The transfer case of claim 5, wherein the shiftable collar is disposed radially within the input shaft in the first position.

7. The transfer case of claim 6, wherein the shiftable collar includes external teeth that drivingly engage with internal teeth of the main shaft.

8. The transfer case of claim 1, wherein the input shaft has a first end and a second end, wherein the second end is disposed radially within the bearing plate assembly.

9. The transfer case of claim 8, wherein the second end of the input shaft has a cylindrical outer surface and toothed inner surface having internal teeth, wherein the internal teeth engage external teeth of the shiftable collar in the first position.

10. The transfer case of claim 9, wherein the cylindrical outer surface is supported by a bearing of the bearing plate assembly.

11. The transfer case of claim 8, wherein the bearing plate assembly includes a bearing plate received in the bore and in contact with an inner surface of the bore, and further includes a bearing supported radially within the bearing plate, wherein the bearing of the bearing plate assembly supports the second end of the input shaft.

12. The transfer case of claim 8, wherein the bearing plate assembly is exchangeable with a planetary gear assembly configured for being received in the bore, wherein the input shaft is exchangeable with a further input shaft having a sun gear formed on an outer radial surface that drives the planetary gear assembly, wherein the planetary gear assembly includes a ring gear received in the bore.

13. The transfer case of claim 1, wherein the shiftable collar is rotatable with the first output gear, wherein the shiftable collar engages with a non-rotatable shift fork, wherein the shiftable collar is rotatable relative to the shift fork, wherein controlled actuation of the shift fork controls the position of the shiftable collar.

14. The transfer case of claim 1, wherein in the first position, the shiftable collar, a second end of the input shaft, and the bearing plate assembly each occupy a common axial plane.

15. A method of operating a transfer case, the method comprising the steps of:
providing a housing having a bore;
disposing an input shaft within the housing;
disposing a first output shaft within the housing;
disposing bearings within said housing that respectively support the input shaft and the first output shaft
disposing a bearing plate assembly in the bore and providing support to the input shaft via the bearing plate assembly;
positioning a dog clutch around the first output shaft, wherein the dog clutch includes a shiftable collar that is axially moveable along the first output shaft;
providing a power-operated actuation mechanism that axially moves a shiftable collar;
actuating the shiftable collar into a first position, wherein the shiftable collar provides torque transfer between the input shaft and the first output shaft,
actuating the shiftable collar into a second position and interrupting torque transfer between the input shaft and the first output shaft.

16. The method of claim 15, further comprising, in the second position, operating the transfer case in a neutral mode and rotating the first output shaft independent from the input shaft.

17. The method of claim 16, wherein the shiftable collar rotates with the first output shaft.

18. The method of claim 15, further comprising, in the first position, operating a second output shaft in response to rotation of the input shaft and the first output shaft.

19. The method of claim 15, wherein the input shaft and the first output shaft rotate at the same rate in the first position.

20. The method of claim 15, further comprising exchanging the bearing plate assembly with a planetary gear assembly in the bore.
